(19) United States
(12) Patent Application Publication
(10) Pub. No.: US 2009/0327054 A1
(43) Pub. Date: Dec. 31, 2009

(54) PERSONAL REPUTATION SYSTEM BASED ON SOCIAL NETWORKING

(75) Inventors: Goden YAO, Shanghai (CN); April TU, Shanghai (CN); Melora ZANER-GODSEY, Shanghai (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,507

(22) Filed: Jun. 27, 2008

(51) Int. Cl. G06Q 99/00; G06Q 10/00

(52) U.S. Cl. 705/12; 705/1

(57) ABSTRACT

Embodiments of the claimed subject matter provide a personal reputation system based on user behavior and activity within one or more social networks, and the migration of reputation-based data therein. One embodiment is implemented as a system for developing the personal reputations of users of the system belonging to a shared social network. Each user is associated with a personal profile, which represents the user within the social network. Each personal profile includes a personal reputation index representing the reputation of the corresponding user of the system, one or more personal tags attached to the personal profile, and a list of other users with acknowledged affiliations with the corresponding user.

### BACKGROUND

The unprecedented speed, versatility, and capacity available through which information can be communicated and disseminated over the Internet have enabled the rise of entirely new methods of communication. Among these new methods include email, internet relay chats, and instant messaging. These features, in conjunction with the popularization of Internet usage, have also enabled the rise of entirely new techniques for social interaction, such as electronic social networking systems. Not surprisingly, the number and popularity of social networking systems has increased as a response to increases in both Internet users and the sophistication and functionality of social interaction services provided by social networking systems. Currently, a few social networking services accessed by users over the Internet comprise some of the most popular (i.e., most often accessed) websites in the world today.

Social networking websites often provide a content page for each member account of the website. The content page of a member account is typically presented to other members as the user's “profile,” which may include basic information supplied by the user such as the user's name, age, profession, marital status and education. Some social networking sites also provide one or more areas for the user to describe the user's personality and/or interests. Other features commonly available to many social networking sites include providing a web log (“blog”) and the ability to store and display photographs for each user account. For security and/or privacy reasons, social networking websites may allow the user to set the level of visibility for the user's content page. For example, a user may allow certain identified users designated as “friends” of the user to view and access the content page of the user. For unauthorized users, some or all portions of the user's profile may be obscured or inaccessible. Additionally, communication through social networking websites may also be available only to the specifically authorized users (e.g., “friends”).

Another feature offered by nearly every social networking website is a “friend” or “buddy” list, which is a feature that allows users of the site to view the accumulation of other users designated as friends. Often, when a user seeks to designate another user as a friend within a social networking context, the other user must also mutually affirm the designation. The process of identifying or confirming a friendship may be quite simple, such as merely requiring a user to request a friendship with another, target user, and for the target user to accept that the requesting user is a friend. Member profiles from popular social networking websites will commonly include a list of all the identified friends of that user. In many social networking websites, the confirmed friends of a user are able to (at least partially) view, and/or access the profiles of other confirmed friends of the user, often with an imputed default authority, subject to change.

Yet another feature often available on popular social networking websites is the ability to search for other users, by name, for example, and/or according to keywords (e.g., specific interests, personality traits, etc.) This allows a user to determine whether a friend or an associate is also a member of the social networking website, or to find other members with shared interests, thus fulfilling the “social networking” aspect.

However, within online social networking communities, meeting appropriate new people that match a user's interests and/or preferences can often be difficult, even with the ability to search for other users. Specifically, due to the inherent anonymity of the Internet, users are often wary or hesitant to trust other users they meet over the Internet. Even a user's purported basic information and/or interests may be inaccurate due to the difficulty in monitoring and verifying user-generated content. Subsequently, there remains no efficient way to extend a person's group of friends or personal networks by finding people with legitimately the same interests, personalities, or hobbies through current social networks.

Furthermore, the relative instability of many social network websites due to newly emerging social networking sites, countervailing trends and constantly fluctuating public interest keep the social networking landscape in a state of near constant flux. For example, significant portions of populations of online social networking users may migrate from previous industry leaders to the prevailing social network website of the time. Unfortunately, as many of the most popular social network websites remain independent from others, data is not commonly shared between social network websites. Accordingly, every time a user moves from one online community to another, the user has to reestablish an account with the social network, re-earn a reputation within the online community, and re-identify friendships with other members. Naturally, this process can be rather inefficient, user-intensive, and time consuming.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments are directed to personal reputation systems within the context of social networking. Specifically, a personal reputation system based on user behavior and activity within one or more social networks, and the migration of reputation-based data therein, is provided.

One embodiment is implemented as a personal reputation system used within the context of a social networking community. A user of the system is supplied with a personal profile, representing the user to other users of the system. The personal profile may include, for example, basic information about the user that the user has agreed to disclose. A personal profile also comprises a personal reputation index, representing the user's achieved reputation within the context of the social network. The reputation index is generated from certain values attributed to the user based on the user's behavior within the social network community, the basic information regarding the user and the reputation of the user's affiliates within the social network.

A personal profile of a user may also include personal tags, comprising one or more descriptive terms or short phrases that other users of the system has attributed to the user, or would use to characterize the user. Each personal tag further includes an indication—based on collected votes—for the accuracy of the personal tag, and the reputations of those submitting votes on the personal tag.

Another embodiment is implemented as a method for evaluating collected votes for personal tags in a personal reputation system. The method includes collecting votes for the personal tags from eligible votes. Voter eligibility may vary, according to system and/or user preference (e.g. only other users known to the user whose personal tag is being voted on are eligible to vote). An eligible user is able to vote in support or dissent of the personal tag, as applied to the user. The accuracy of the personal tag, as applied to the user, is calculated from the voting results by parsing the recorded votes in support of the personal tag and the votes in dissent of the personal tag to generate a ratio of accuracy. The credibility of the personal tag is also generated from the reputation indices of all users submitting votes.

Another embodiment is implemented as a method for migrating data from a first reputation system to a second reputation system. Migrated data may, for example, include reputation data (e.g., the personal reputation index, behavior records and the list of affiliated users). According to this embodiment, connection between the systems is established and the requested data is extracted from the first reputation system. The data is then assimilated to user presences established in the second reputation system for the corresponding users.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a diagram of a personal reputation in a personal reputation system in accordance with various embodiments.

FIG. 2 depicts a graphical representation of a personal profile in accordance with various embodiments.

FIG. 3 depicts an exemplary graphical representation of a personal profile with a displayed voting interface displayed in accordance with various embodiments.

FIG. 4 depicts an exemplary graphical representation of a personal profile with a displayed personal tag submission interface to submit a personal tag in accordance with various embodiments.

FIG. 5 depicts an exemplary graphical representation of an user interface featuring search functionality in accordance with various embodiments.

FIG. 6 depicts a flowchart of a method of evaluating a personal tag associated with a user in a personal reputation system in accordance with various embodiments.

FIG. 7 depicts a flowchart of a method of automatically migrating reputation data of a user from a first system in a social network to a second system in a social network in accordance with various embodiments.

FIG. 8 depicts a block diagram of an exemplary computer system in accordance with various embodiments.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

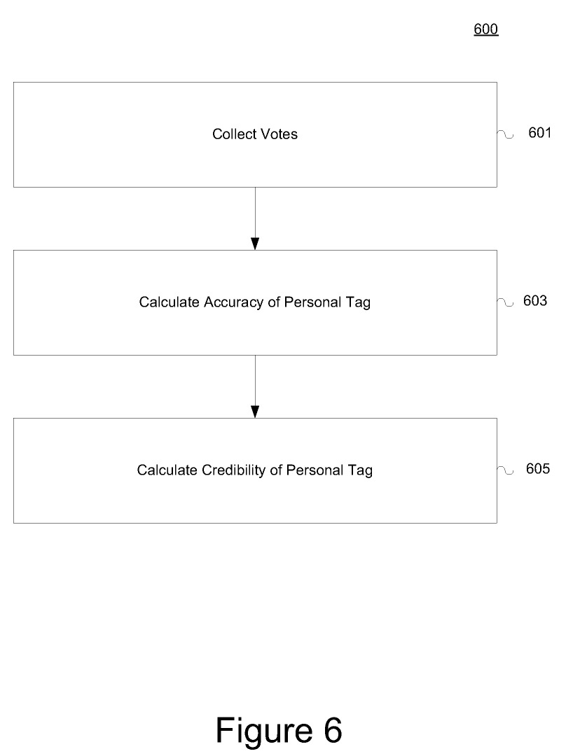

Portions of the detailed description that follows are presented and discussed in terms of a method. Although steps and sequencing thereof are disclosed in a figure herein (e.g., FIG. 6) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the following embodiments, an approach is described for a personal reputation system based on user behavior and activity within one or more social networks, and the migration of reputation-based data therein. In several of these embodiments, a reputation index is used to describe the representation of the reputation achieved by a user amongst other users of the system with the social network.

### Personal Reputation Structure

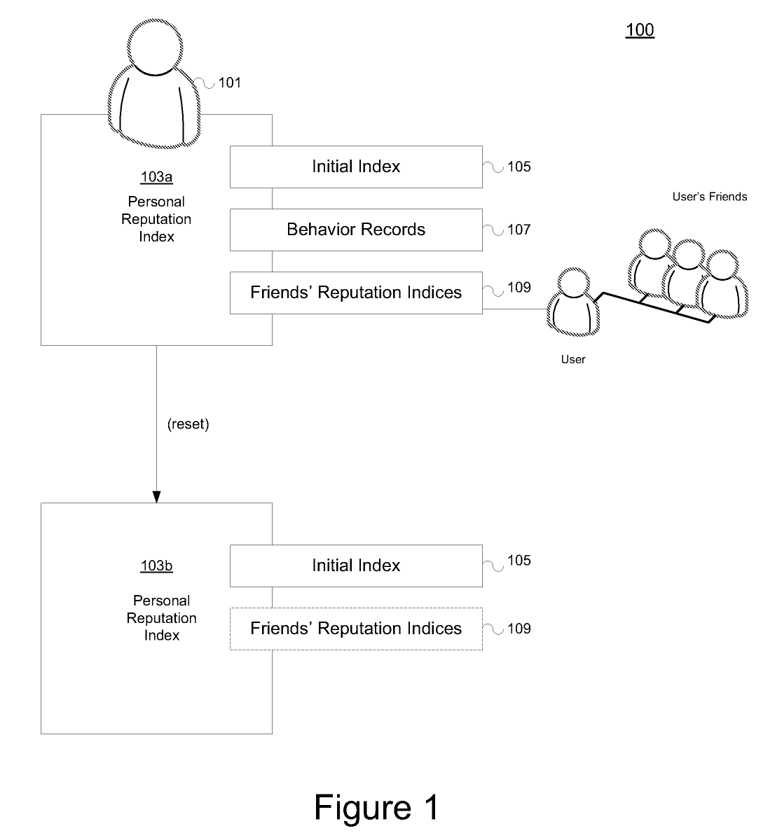

With reference now to FIG. 1, personal reputation 100 in a personal reputation system is depicted in accordance with one embodiment. While personal reputation 100 is shown as incorporating specific, enumerated features and elements, it is understood that embodiments are well suited to applications involving additional, fewer, or different features, elements, or arrangements.

Personal reputation 100 is shown to represent the personal reputation of a user 101 of a personal reputation system in a social networking community. The personal reputation 100 of user 101 may represent established personal reputation index 103a, or personal reputation index which is new or has been recently reset 103b. One or more personal reputations may be stored in a data storage component comprised in (or accessible to) the personal reputation system, such as a database.

Established personal reputation index 103a combines initial index 105, behavior records 107, and friends' reputation indices 109 of the user 101. Initial index 105 represents a score or value generated by the system for user 101 when user 101 joins the social networking community (e.g., establishes an account with a personal reputation system). The score or value represented by initial index 105 is calculated to account for certain basic information regarding user 101. In one embodiment, initial index 105 is a score which reflects the aggregated pre-assigned values for certain attributes such as the age, education and/or work experience of user 101. In one embodiment, the attributes (e.g. age, education, work experience) comprising the initial index is calculated at the time user 101 joins the social networking community and is invariable. In another embodiment, the initial index may be updated periodically (thereby adjusting the user's personal reputation index 103) to reflect modified attributes.

Behavior records 107 represents a score or value generated by the system for user 101 based on the record of behavior of user 101 within the social networking community. Behavior of user 101 includes actions performed by the user within the social networking community. The behavior records of user 107 may reflect “negative” or “bad” actions which are associated with the user. One example includes negative reports or complaints regarding the user's activity or behavior submitted by other users. Another example includes rule-based offenses. For example, certain social networking systems include one or more public forums for users of the system to engage in discussion. These forums may have rules against inappropriate behavior (e.g., swearing, posting offensive or sexually inappropriate pictures). Failure to comply with these rules may also be reflected in behavior records 107 of user 101. In contrast, behavior record 107 of user 101 may be positively affected by positive comments or reports submitted by other users, high levels of user activity (e.g., frequent posting on public forums) over a period of time without complaints.

A user who is new to the personal reputation system and/or the social networking community may have no record of behavior. Accordingly, the personal reputation index of a new user, depicted as 103b, will not include the behavior records of the user 107 in its calculation.

In some embodiments, the personal reputation system for social networking may include a friends or buddies list for each user. These systems allow a user to designate one or more other users of the personal reputation system as a friend (often subject to approval by the other users). A friends list for user 101 therefore comprises the other users (mutually) designated by user 101 as a friend. Friends' reputation indices 109 reflect the personal reputation indices of the other users comprising the friends list of user 101. Accordingly, high average personal reputation indices of the other users comprising the friends list of user 101 will have a positive impact on the personal reputation index of the user 103a. Low average personal reputation indices may negatively adjust the personal reputation index of the user 103a.

In some embodiments, the personal reputation system may include a feature to allow a user 101 to reset the user's reputation. If user 101 elects to utilize this feature, the behavior records of the user 107 are dissociated from the personal reputation index of the user. The personal reputation index of the user 103b after the behavior records are purged will include the initial index of the user 105. In some embodiments, user 101 is able to retain the user's friends list through a reputation reset (while behavior records are never retained). Accordingly, for these embodiments, the personal reputation index of the user 103b will also include the Friends' Reputation Indices 109.

In further embodiments, the ability to reset a reputation may be restricted. For example, a user's ability to reset his or her reputation may be temporally restricted (e.g., once every six months). In alternate embodiments, a user's ability to reset his or her reputation may be reputation restricted (e.g., only reputations under a pre-determined threshold may be reset).

According to one embodiment, the profile of a user with a recently reset reputation may provide notice to viewing users that the reputation has been recently reset. For example, the personal profile of a user with a recently reset reputation may display a message indicating that the user's reputation has been reset. The message may be displayed for a pre-determined duration immediately following the reputation reset (e.g., one month). In further embodiments, the pre-determined duration after a reputation reset may be increased (linearly or exponentially) for every subsequent reputation reset.

### Exemplary Personal Profile

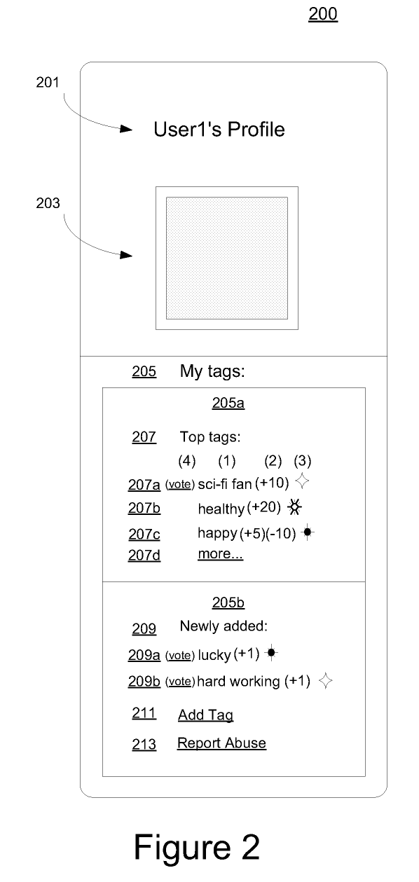

With reference now to FIG. 2, a graphical representation of personal profile 200 is depicted, in accordance with one embodiment. While personal profile 200 is shown as incorporating specific, enumerated features and elements, it is understood that embodiments are well suited to applications involving fewer, additional, or different features, elements, or arrangements.

In the depicted embodiment, personal profile 200 is a graphical representation of data regarding a user in a personal reputation system based on social networking, Personal profile 200 includes reference to the user associated with the personal profile 201 (“reference”). In one embodiment, reference 201 displays the name (e.g., first name, last name, or both) of the user. In other embodiments, reference 201 may also display the user's nickname, the user's account or “screen” name, or the email account of the user. Personal profile 200 includes graphical display area 203 which presents one or more visual or graphical displays. In one embodiment, graphical display area 203 displays one or more photographs selected by the user. In another embodiment, graphic display area 203 displays one or more graphical icons selected by the user or system to represent the user.

Personal profile 200 also includes a section for personal tags 205. In one embodiment, the section for personal tags 205 includes a headline or other demarcation (e.g., “My Tags”). Personal tags are terms or short phrases which other users have used to “tag” the user 201 with. In one embodiment, the personal tags are specific characteristics associated with the user. For example, a personal tag may be a descriptive quality other users believe the user possesses or exemplifies. Another example may be a specific taste or preference of the user, as noticed by other users. In one embodiment, a user may only attach personal tags on other users. A user who accesses (e.g. navigates to) the personal profile of another user may view that user's tags. In embodiments where a user is able to limit viewing of the user's personal profile to certain other users or classes of users, only the users with access to the user's personal profile may view the user's personal tags.

In some embodiments, the ability to attach a tag to a specific user may also be limited, e.g., only registered users of the system may tag a specific user, and/or only registered users currently accessing (e.g. “logged in” to) the system's services may tag a specific user, and/or only the users designated as a friend may tag a user with a personal tag. Each tag may further accumulate votes, e.g., supported or dissented. For example, if a user disagrees with the applicability of a personal tag of another user, the user may vote against the tag. Conversely, if the user agrees with the personal tag of another user, the user may vote in support of the tag. Votes for each personal tag are recorded by the system.

In further embodiments, the ability to vote for a tag is synchronized with the ability to attach a tag (i.e., a user can only vote on the personal tags of other users, and only users designated as friends by a user may vote on the tag of the user). In further embodiments, votes are limited to one vote per personal tag per voting user. For example, for any user with one or more personal tags, the other users designated as friends of the user may each vote once for each personal tag associated with the user.

Each personal tag includes and displays three elements: (1) the name of the tag (e.g., the characteristic or descriptive phrase), (2) the accuracy of the tag (e.g., voting results of the tag), and (3) the credibility of the tag. In some embodiments, a personal tag will also include a fourth element: an indication that a viewing user may vote on a personal tag. The accuracy of the personal tag indicates the amount of votes each personal tag has generated from other users. In some embodiments, the display of the voting results of the tag further delineates between supporting votes and dissenting votes, e.g. the number of supporting votes is demarcated with a “+,” while the number of dissenting votes is demarcated with a “−”.

The credibility index of a personal tag reflects the average reputation of the users who have voted on the personal tag. Thus, a higher average reputation of the users who have voted on the personal tag, will result in a higher credibility index for the personal tag. The credibility index may be represented in a variety of ways, e.g., as differing colors and/or shapes and/or figures representing a scale or spectrum of credibility. FIG. 2 visualizes the credibility index as a scale of solar figures of variable luminescence. As such, a brighter figure indicates a high credibility index, whereas dim or dark figures indicate low credibility indices.

The section for personal tags 205 is further divided to include two portions: a top portion 205a, and a bottom portion 205b. Top portion 205a displays top tags 207. Top tags 207 displays personal tags of the user which have generated the most votes from other users. In some embodiments, the number of displayed personal tags is adjustable by the system and/or the user. Top tags 207 may be visualized in a variety of ways, e.g., the number of personal tags selected for display may be presented in descending order of credibility, based on the credibility of the personal tag. The personal tags selected for display may also be presented based on the number of supporting votes generated by the personal tag.

With reference to FIG. 2, top tags 207 is a list of exemplary personal tags associated with the personal profile 200 of a user. According to top tags 207, the list of displayed personal tags includes exemplary personal tag 207a (“sci-fi fan”), exemplary personal tag 207b (“healthy”), and exemplary personal tag 207c (“happy”). Top tags 207 also includes link 207d (designated here as “more . . . ”) that a viewer may utilize to view personal tags attached to personal profile 200 not currently displayed in top tags 207. Personal tag 207a (“sci-fi fan”), as shown, displays the four elements herein described for personal tags. Personal tag 207a displays (1) the name of the personal tag (“sci-fi fan”). Personal tag 207a also displays (2) the aggregated voting results of the personal tag (“+10”), indicating that ten users have voted in support of the personal tag as an accurate descriptor of the user. Absence of a number indicating the number of dissenting votes implies that there are no dissenting votes currently recorded for the personal tag.

Personal tag 207a further includes (3) the credibility of the personal tag, as an average of the reputation of the users that have voted (either in support or dissent) for the personal tag. The credibility of personal tag 207a is presented as a brightly glowing star. Personal tag 207a also includes (4) an indication that the viewing user may vote on the personal tag (i.e., has yet to vote on the personal tag). This indication is displayed as “(vote).” As such, a viewer of exemplary personal profile 200 is still eligible to vote on personal tag 207a. The indication would not be displayed to ineligible voters. In one embodiment, the indication is implemented as a link that opens a window that allows the viewer to submit a vote.

Personal tag 207b displays (1) the name of the personal tag (“healthy”). Personal tag 207b also displays (2) the aggregated voting results of the personal tag (“+20”), indicating that twenty users have voted in support of the personal tag as an accurate descriptor of the user. Absence of a number indicating the number of dissenting votes implies that there are no dissenting votes currently recorded for the personal tag.

Personal tag 207b further includes (3) the credibility of the personal tag, as an average of the reputation of the users that have voted (either in support or dissent) for the personal tag. The credibility of personal tag 207b is presented as a dimly glowing star. Accordingly, the credibility index of personal tag 207b is depicted as lower than the credibility index of personal tag 207a (i.e., the average reputation of the users who have voted on personal tag 207b is lower than the average reputation of the users who have voted on personal tag 207a). Personal tag 207b does not display (4) an indication that the viewing user may vote on the personal tag. As such, the viewer of exemplary personal profile 200 is not eligible to vote on personal tag 207b.

Personal tag 207c displays (1) the name of the personal tag (“happy”). Personal tag 207c also displays (2) the aggregated voting results of the personal tag “(+5)(−10),” indicating that five users have voted in support of the personal tag as an accurate descriptor of the user, whereas ten users have voted in dissent of the personal tag as an accurate descriptor of the user.

Personal tag 207c further includes (3) the credibility of the personal tag, as an average of the reputation of the users that have voted (either in support or dissent) for the personal tag. The credibility of personal tag 207c is presented as a darkened star. Accordingly, the credibility index of personal tag 207c is depicted as lower than the credibility index of both personal tag 207a and personal tag 207b (i.e., the average reputation of the users who have voted on personal tag 207c is lower than the average reputation of the users who have voted on personal tags 207a and 207b). Personal tag 207c does not display (4) an indication that the viewing user may vote on the personal tag. As such, the viewer of exemplary personal profile 200 is not eligible to vote on personal tag 207c.

Bottom portion 205b displays functionality available through a personal profile 200 not included in top portion 205a. Bottom portion 205b includes a newly added tags section 209. Newly added tags section 209 displays a number of personal tags that have been most recently attached to the personal profile 200 of the user. In one embodiment, newly added tags section 209 may be limited to personal tags which have been attached within a pre-determined period of time (e.g., within the past month). As with the personal tags displayed in top tags 207, the number of displayed personal tags in newly added tags section 209 may be adjustable by the system and/or the user. As shown, newly added tags section 209 includes a list of exemplary personal tags. Newly added tags section 209 includes exemplary personal tag 209a (“lucky”) and exemplary personal tag 209b (“hard working”).

Personal tag 209a, as shown, displays the four elements herein described for personal tags. Personal tag 209a displays (1) the name of the personal tag (“lucky”). Personal tag 207a also displays (2) the aggregated voting results of the personal tag (“+1”), indicating that only a single user has voted in support of the personal tag as an accurate descriptor of the user. The absence of a number indicating the number of dissenting votes implies that there are no dissenting votes currently recorded for the personal tag.

Personal tag 209a further includes (3) the credibility of the personal tag, as an average of the reputation of the users that have voted (either in support or dissent) for the personal tag. The credibility of personal tag 209a is presented as a darkened star, indicating a low level of credibility. Personal tag 209a also includes (4) an indication that the viewing user may vote on the personal tag (i.e., has yet to vote on the personal tag). This indication is displayed as “(vote).” As such, a viewer of exemplary personal profile 200 is still eligible to vote on personal tag 207a. The indication would not be displayed to ineligible voters. In one embodiment, the indication is implemented as a link that opens a window that allows the viewer to submit a vote.

Personal tag 209a, as shown, displays the four elements herein described for personal tags. Personal tag 209a displays (1) the name of the personal tag (“lucky”). Personal tag 209a also displays (2) the aggregated voting results of the personal tag (“+1”), indicating that only a single user has voted in support of the personal tag as an accurate descriptor of the user. The absence of a number indicating the number of dissenting votes implies that there are no dissenting votes currently recorded for the personal tag.

Personal tag 209a further includes (3) the credibility of the personal tag, as an average of the reputation of the users that have voted (either in support or dissent) for the personal tag. The credibility of personal tag 209a is presented as a darkened star, indicating a low level of credibility. Personal tag 209a also includes (4) an indication that the viewing user may vote on the personal tag (i.e., has yet to vote on the personal tag). This indication is displayed as “(vote).” As such, a viewer of exemplary personal profile 200 is still eligible to vote on personal tag 207a.

Personal tag 209b, as shown, displays the four elements herein described for personal tags. Personal tag 209a displays (1) the name of the personal tag (“hard working”). Personal tag 209b also displays (2) the aggregated voting results of the personal tag (“+1”), indicating that only a single user has voted in support of the personal tag as an accurate descriptor of the user. The absence of a number indicating the number of dissenting votes implies that there are no dissenting votes currently recorded for the personal tag.

Personal tag 209b further includes (3) the credibility of the personal tag, as an average of the reputation of the users that have voted (either in support or dissent) for the personal tag. The credibility of personal tag 209b is presented as a brightly glowing star, indicating a high level of credibility. Personal tag 209b also includes (3) an indication that the viewing user may vote on the personal tag (i.e., has yet to vote on the personal tag). This indication is displayed as an asterisk. As such, the viewer of exemplary personal profile 200 is still eligible to vote on personal tag 209b.

Bottom portion 205b also includes add tag feature 211 and report abuse feature 213. Add tag feature 211 allows a viewer to attach a personal tag to the personal profile 200 of a user. In one embodiment, add tag feature 211 may be implemented as a link, which, when clicked by an eligible viewer, opens a window that allows the viewer to enter the keyword or phrase that describes the user whose personal profile 200 the viewer is attempting to attach a personal tag to. As provided previously, the ability to attach personal tags to the personal profile 200 of a user may be limited (e.g., only other users designated as a friend of the user may attach a personal tag to the personal profile 200 of the user).

Report abuse feature 213 allows a viewer to report misbehavior or misconduct expressed by a user and/or through the personal profile 200 of the user.

In one embodiment, report abuse feature 213 may be implemented as a link, which when clicked by a viewer, opens a window that allows the view to submit a complaint.

In one embodiment, a user who elects to reset the user's reputation may also elect to purge personal tags attached to the user's personal profile.

### Vote Submission Interface

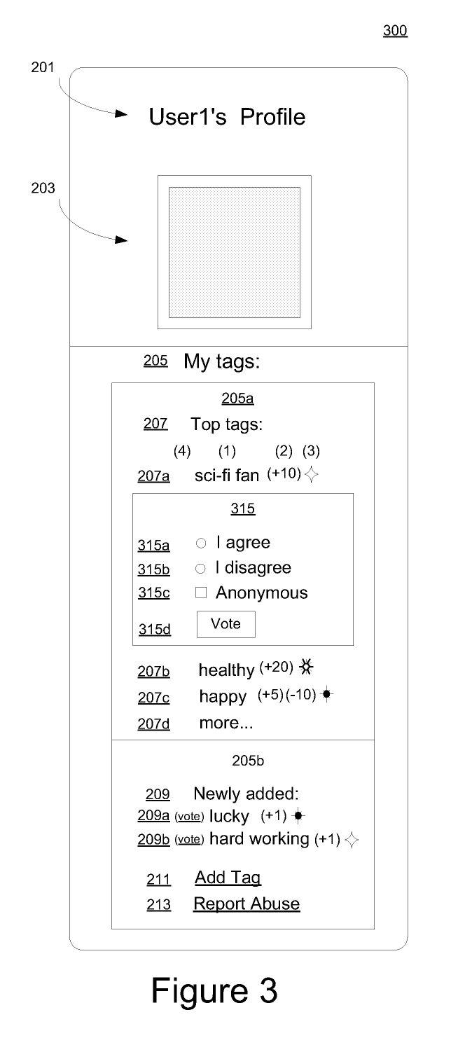

With reference now to FIG. 3, an exemplary graphical representation of a personal profile with a displayed voting interface is depicted as personal profile 300, in accordance with one embodiment. While personal profile 300 is shown as incorporating specific, enumerated features and elements, it is understood that embodiments are well suited to applications involving fewer, additional, or different features, elements, or arrangements.

In the depicted embodiment, personal profile 300 is an exemplary graphical representation of personal profile 200 with an additional voting interface displayed. Personal profile 300 includes several elements of personal profile 200, herein incorporated by reference. Personal profile 300 includes reference to the user 201, graphical display 203, add tag feature 211 and report abuse feature 213. Personal profile 300 also includes a section for personal tags 205 with top portion 205a and bottom portion 205b. Top portion 205a displays top tags 207, including exemplary personal tag 207a (“sci-fi fan”), exemplary personal tag 207b (“healthy”), and exemplary personal tag 207c (“happy”). Top tags 207 also includes a link to 207d attached to the personal profile 300 (designated here as “more . . . ”) that a viewer may utilize to view personal tags attached to personal profile 200 not currently displayed in top tags 207. Bottom portion 205b includes a newly added tags section 209. Newly added tags section 209 includes exemplary personal tag 209a (“lucky”) and exemplary personal tag 209b (“hard working”). These elements are identical to the elements as described in the detailed description of FIG. 2.

Personal tag 207a further includes voting window 315. Voting window 315 allows a viewer to vote either in support or dissent of a personal tag attached to a user. Voting window 315 includes an option to support 315a, an option to dissent 315b, and an option to submit the vote 315d. In one embodiment, a user is able to view the origin (e.g., the voter) of votes for some or all of the personal tags attached to the personal profile of the user. In a further embodiment, voting window 315 includes an anonymous option 315c, which enables a voter to submit a vote anonymously (with respect to the user). Thus, if enabled, the user will be able to view the vote (e.g., either dissent or support) but not the origin of the vote.

### Personal Tag Submission Interface

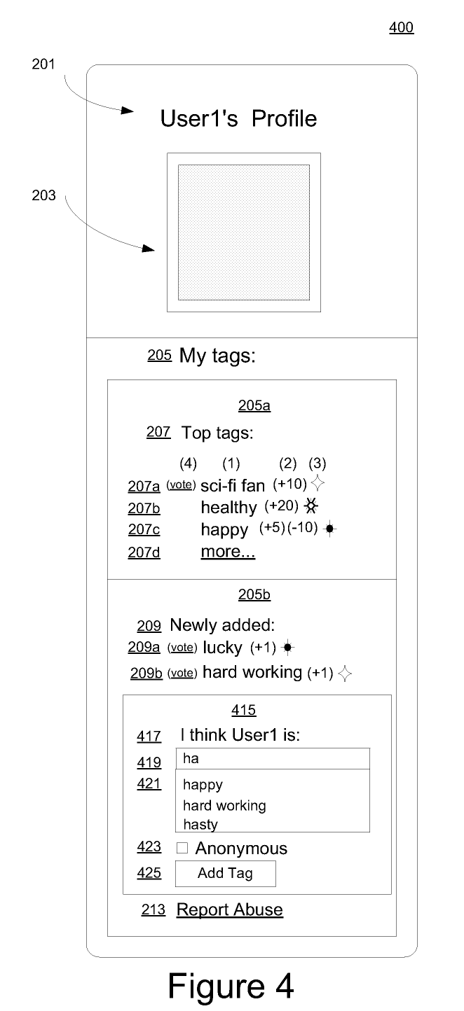

With reference now to FIG. 4, an exemplary graphical representation of a personal profile with a displayed personal tag submission interface is depicted as personal profile 400, in accordance with one embodiment. While personal profile 400 is shown as incorporating specific, enumerated features and elements, it is understood that embodiments are well suited to applications involving fewer, additional, or different features, elements, or arrangements.

In the depicted embodiment, personal profile 400 is an exemplary graphical representation of personal profile 200 with an additional interface to submit personal tags displayed. Personal profile 400 includes several elements of personal profile 200, herein incorporated by reference. Personal profile 400 includes reference to the user 201 and graphical display 203. Personal profile 400 also includes a section for personal tags 205 with top portion 205a and bottom portion 205b. Top portion 205a displays top tags 207, including exemplary personal tag 207a (“sci-fi fan”), exemplary personal tag 207b (“healthy”), and exemplary personal tag 207c (“happy”). Top tags 207 also includes link 207d (designated here as “more . . . ”) that a viewer may utilize to view personal tags attached to personal profile 200 not currently displayed in top tags 207. Bottom portion 205b includes newly added tags section 209, add tag feature 211 and report abuse feature 213. Newly added tags section 209 includes exemplary personal tag 209a (“lucky”) and exemplary personal tag 209b (“hard working”). These elements are identical to the elements as described in the detailed description of FIG. 3.

As shown in FIG. 4, bottom portion 205b now includes an expanded add tag window 415. Expanded add tag window 415 allows a viewer to submit a personal tag to attach to the personal profile 200 of the user. In one embodiment, expanded add tag window 415 includes introduction 417, field for user input 419, field for system-generated suggestion 421, and option to submit the personal tag 425.

In one embodiment, a user is able to view the origin (e.g., the tagging user) of personal tags attached to the personal profile of the user. In one embodiment, introduction 417 is implemented as a short explanatory message or instructional phase. Field for user input 419 enables the tagging user to enter the term or short phrase that the tagging user would like to attach as a personal tag to the personal profile 200 of the first user 201.

Field for system-generated suggestion 421 is implemented as a window (e.g., a dynamically-sized drop down window) which displays suggested terms or short phrases responsive to the input of the tagging user in field for user input 419. As shown, field for user input 419 includes exemplary letters “ha.” Field for system-generated suggestion 421 displays terms or short phrases corresponding to the entered user input (e.g., “happy,” “hard working,” “hasty”). In a further embodiment, expanded add tag window 415 includes an anonymous submission option 423, which enables an eligible tagging user to attach a personal tag vote anonymously (with respect to the user). Thus, if enabled, the user will be able to view the personal tag but not its origin.

In one embodiment, each newly added personal tag automatically appears in the list of personal tags in the personal profile of the corresponding user. For example, once a personal tag has been added, the tag may appear within newly added tags section 209 in the personal profile of the corresponding user. In one embodiment, a newly added personal tag may be created with an initial vote (indicating the assenting vote of the user attaching the tag). In a further embodiment, a newly added personal tag may also be created with an initial credibility equal to the reputation score of the user attaching the tag. Subsequent votes would recalculate the credibility of the newly added personal tag by averaging the reputation score of the users submitting votes for the personal tag.

In alternate embodiments, a newly added tag is created without an initial vote (either in assent or dissent), and/or credibility. The user attaching the tag may be eligible to vote on the tag after the tag has been attached, whereupon the user's reputation is factored into the calculation of the credibility of the attached personal tag according to the procedures described above. According to an alternate embodiment, a user may be ineligible to vote on the personal tags the user has attached to the personal profile of other users.

In one embodiment, notice may be provided to a corresponding user whose personal profile has received an additional attached personal tag. In further embodiments, notice may be extended to other users with affiliation with the corresponding user whose personal profile has received an additional attached personal tag. For example, other users who are eligible to vote on a newly attached personal tag of a corresponding user (e.g., users in the “friends list” of the corresponding user) may also receive notice that a new personal tag has been attached to the personal profile of the corresponding user. Notice may be configurable according to user preference, and may include (but is not limited to) notification through email or through a proprietary message system in the reputation system (or social networking system).

### Exemplary Search Interface

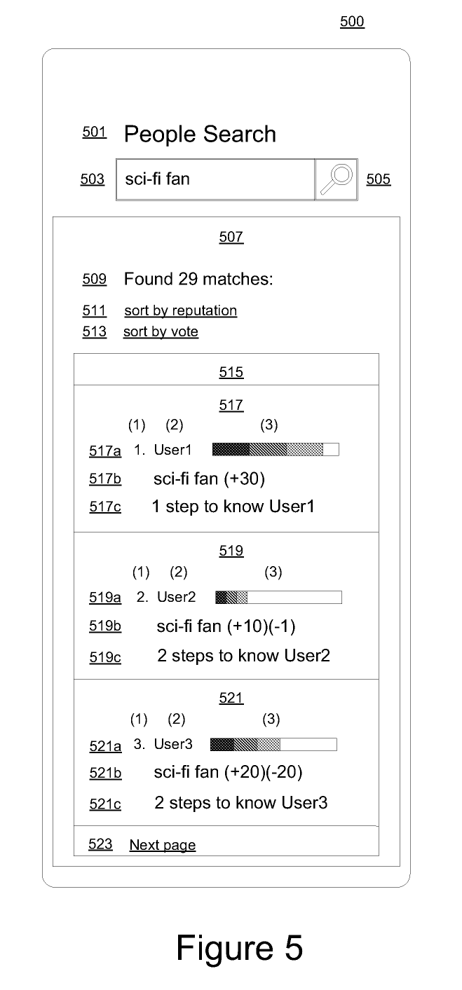

With reference now to FIG. 5, an exemplary graphical representation of a user interface featuring search functionality is depicted as search interface 500, in accordance with one embodiment. While search interface 500 is shown as incorporating specific, enumerated features and elements, it is understood that embodiments are well suited to applications involving fewer, additional, or different features, elements, or arrangements.

In the depicted embodiment, search interface 500 is an exemplary graphical representation of a user interface in a personal reputation system featuring search functionality. Search interface 500 includes feature title 501, user input field 503, user submission button 505, and search result display 507. As shown, feature title 501 presents the name or title of the feature, or otherwise operating as a visual indication to the viewer of the purpose of the feature (e.g., “people search”).

User input field 503 enables the searching user to submit a search query (e.g., a descriptive term or short phrase) for personal tags attached to the personal profiles of other users that correspond to the input (e.g. search terms) entered by the user. If the search query matches a personal tag known in the system (i.e., already attached to one or more personal profiles), the personal profiles which have the personal tags attached will be included and displayed in the search result list. If the search query does not match a personal tag already known in the system, the system determines the closest approximations, and will include and display the personal profiles that have the personal tags which most closely approximate the search query. In one embodiment, the system will limit the number of personal profiles included in a search result list to a pre-defined maximum number of personal profiles (e.g., fifty personal profiles). In such embodiments, if the number of personal profiles with attached tags that match the search query is less than the pre-defined maximum number of personal profiles, personal profiles with attached tags that approximate the search query may be used to supplement the search result list until the search result list reaches the pre-defined maximum number of personal profiles.

By extension, the searching user is able to submit a search query for personal profiles of users which have been tagged by the same (or approximate) personal tag that corresponds to the search query. As depicted in FIG. 5, a searching user has submitted a search query for the phrase “sci-fi fan.” Search interface 500 includes user submission button 505, which enables the user to enter the search query to the system to return a list of other users with attached personal tags that correspond to the searched for term or phrase. In one embodiment, a data resource which contains the reputation data (including personal tags) of the users of the system is searched for the search query, and used to return the list of other users with profiles with attached personal tags which correspond to the search query.

Search result display 507 includes search result list 515, a list of search result entries. In one embodiment, each search result entry is a different personal profile with one or more attached personal tags which correspond to the search query entered by the searching user. If no personal profiles contain attached personal tags that correspond to the search query entered by the searching user, the resulting search result list will be empty. In one embodiment, search result list 515 is an ordered list of search result entries. Search result list 515 may be ordered in a variety of ways (e.g., by relevance, alphabetical, etc.). As shown, search result list 515 includes exemplary search result entries 517, 519, and 521.

In one embodiment, search result list 515 displays a pre-defined number of search result entries simultaneously (e.g., three search result entries). For search result lists which exceed the pre-defined number of search result entries, search result display 507 may include feature for traversing 523 the search result list 515. Feature for traversing 523 the search result list 515 may, for example, be implemented as one or more links to one or more sequentially arranged pages of search result entries of approximately equal distribution, with no page exceeding the pre-defined limit of search result entries.

Search result entries 517, 519 and 521 depict exemplary search result entries. Search result entry 517 includes a reference 517a to a “target user,” e.g., the personal profile of a user with a personal tag attached to the personal profile which corresponds to the submitted search query. Reference 517a further includes three separate elements: (1) the number in the search result list 515 of the search result list entry (e.g., “1”); (2) the name associated with the personal profile of the target user (e.g., “User1”); and (3) the reputation of the target user. As depicted, reference 517a is the first search result entry in search result list 515. The reputation of the target user may be visualized in a variety of ways (e.g., as a “bar” of reputation). According to one embodiment, the reputation of a target is represented as a colored bar, with the amount of area colored in the bar directly proportional to the personal reputation index of the user.

Search result entry 517 also includes personal tag reference 517b. As shown, personal tag reference 517b includes the term or phrase comprising the search query (e.g., “sci-fi fan”) and aggregated voting results for the personal tag for the specific user (e.g., “+30”). Accordingly, personal tag reference 517b displays a sci-fi fan personal tag with thirty supporting votes for User1.

Search result entry 517 also includes degrees of separation 517c between the searching user and the target user. Degree of separation 517c represents the imputed “distance” (as a measure of individual relationships) between two or more users. Degree of separation 517c is calculated as one or more available paths between the searching user and the target user. Each path represents a sequence of “steps” (e.g., a chain of links) between the searching user and the target user, with each step in the sequence being a user in the personal reputation system with an identified relationship (e.g., included in the friends list) with the step immediately preceding the step in the sequence (except in the case the searching user) and also the step immediately following the step in the sequence (except in the case of the target user). In each path, the searching user represents the first step in the sequence, and the target user represents the last step in the sequence. In one embodiment, only the shortest calculated path is displayed in degrees of separation 517c. In a further embodiment, a plurality of calculated paths are displayed in degrees of separation 517c, presented in ascending order of number of steps contained in each path. As shown in exemplary degrees of separation 517c, “1 step to know User1,” thus represents a path from the searching user to the target user with one step, e.g., a user in an identified relationship (e.g., friendship) with the searching user is also in an identified relationship with the target user. In short, a path containing one step may represent a mutual friend of the searching user and the target user.

Search result entry 519 and search result entry 521 are alternative exemplary search result entries. Search result entry 519 and search result entry 521 each include a reference 519a, 521a to a “target user,” e.g., the personal profile of a user with a personal tag attached to the personal profile which corresponds to the submitted search query. Reference 519a, 521a both include the same three elements of 517a: (1) the number in the search result list 515 of the search result list entry (e.g., “2,” and “3,” respectively); (2) the names associated with the personal profile of the respective target users (e.g., “User2,” and “User3,” respectively); and (3) the reputation of the respective target user. As depicted, reference 519a is the second search result entry in search result list 515, and reference 521a is the third search result entry in search result list 515. The reputations of the target users are visualized according to the embodiment described in 517a (e.g., a colored bar, the colored area being proportional to the reputation of the user).

As shown, the reputation represented in reference 519a is displayed as a bar with a low area of coloration. Accordingly, the reputation index within the personal reputation system of the target user whose personal profile is referenced in reference 519a is lower than the reputation index within the personal reputation system of the target user whose personal profile is referenced in reference 517a. As depicted, the reputation represented in reference 521a is displayed as a half-colored bar. Accordingly, the reputation index within the personal reputation system of the target user whose personal profile is referenced in reference 521a is lower than the reputation index within the personal reputation system of the target user whose personal profile is referenced in reference 517a, and higher than the reputation index within the personal reputation system of the target user whose personal profile is referenced in reference 519a.

Search result entry 519 also includes personal tag reference 519b. As shown, personal tag reference 519b includes the term or phrase comprising the search query (e.g., “sci-fi fan”) and aggregated voting results for the personal tag for the specific user, e.g., “(+10)(−1).” Accordingly, personal tag reference 519b displays a sci-fi fan personal tag with ten supporting votes and 1 dissenting vote for User2. Search result entry 521 also includes personal tag reference 521b. As shown, personal tag reference 521b includes the term or phrase comprising the search query (e.g., “sci-fi fan”) and aggregated voting results for the personal tag for the specific user, e.g., “(+20)(−20).” Accordingly, personal tag reference 521b displays a sci-fi fan personal tag with twenty supporting votes and twenty dissenting vote for User3.

Search result entry 519 and search result entry 521 also includes degrees of separation between the searching user and the target user (e.g., 519c, 521c, respectively). As shown in exemplary degrees of separation 519c, “2 steps to know User2,” thus represents a path from the searching user to the target user referenced in 519 that encompasses two steps, e.g., a user in an identified relationship (e.g., friendship) with the searching user is also in an identified relationship with another user in an identified relationship with the target user. Degrees of separation 521c also describes a path with two steps (e.g., “2 steps to know User3.” Accordingly, at least one available path from the searching user to the target user referenced in 521 also comprises two steps. As a path comprising two or more steps has been described in the foregoing description, repetition shall be omitted herein.

Sort by reputation feature 511 allows a searching user to sort the search result entries comprising search result list 515 according to the respective reputations of the target users referenced by the search result entries. For example, search result entries referencing target users with higher reputations will be prioritized over search result entries referencing target users with lower reputations. In one embodiment, sort by reputation feature 511 prioritizes the reputations of the target users referenced by the search result entries without regard to the size (in steps) of the degrees of separation between the searching user and the search result entries. In another embodiment, sort by reputation feature 511 prioritizes the reputations of the target users referenced by the search result entries with respect to the size in steps of the degrees of separation between the searching user and the search result entries. For example, search result entries may be presented in ascending order of size in steps of the degrees of separation, but with paths of equal size presented in descending order of reputation.

Sort by vote feature 513 allows a searching user to sort the search result entries comprising search result list 515 according to the number of aggregated votes for the personal tag, corresponding to the search query, attached to the personal profile for the users referenced by the search result entry. For example, search result list 515 will display in descending order, the search result entries that reference users with profiles with attached personal tags, corresponding to the search query, with the highest amount of votes. In one embodiment, only supporting votes for a personal tag are considered in a sort by vote.

### Evaluating Personal Tags

With reference now to FIG. 6, a flowchart 600 of a method of evaluating a personal tag associated with a user in a personal reputation system is depicted, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

With reference to step 601, the total number of votes submitted by users in a personal reputation system for a personal tag attached to a personal profile of a first user is collected. In one embodiment, eligible voters are prompted to vote on the accuracy of a personal tag, as applied to the first user. In some embodiments, a vote can be submitted in either support or dissent. In further embodiments, the eligibility of voters is limited, e.g., only registered users, and/or users with identified relationships with the first user are eligible to vote. In other embodiments, a user is not eligible to vote on a personal tag attached to the user's own personal profile.

With reference to step 603, the accuracy of the personal tag, as applied to first user, is calculated based on the number of votes collected in step 601. Calculation of the accuracy of the personal tag may, for example, comprise calculating the ratio of supporting votes relative to the number of dissenting votes. In one embodiment, the accuracy of the personal tag may be represented as two individual values, with the number of supporting votes representing one value, and the number of dissenting votes representing the second value.

With reference to step 605, the credibility of the personal tag is calculated. The credibility of the personal tag is calculated from the reputations of users submitting votes. In one embodiment, the credibility of the personal tag is calculated by averaging the reputation indices of all users submitting votes. In a further embodiment, the credibility of the personal tag is presented as the average reputation index. In an alternate embodiment, the credibility of the personal tag is calculated as the median reputation index of users submitting votes.

### Reputation Data Migration

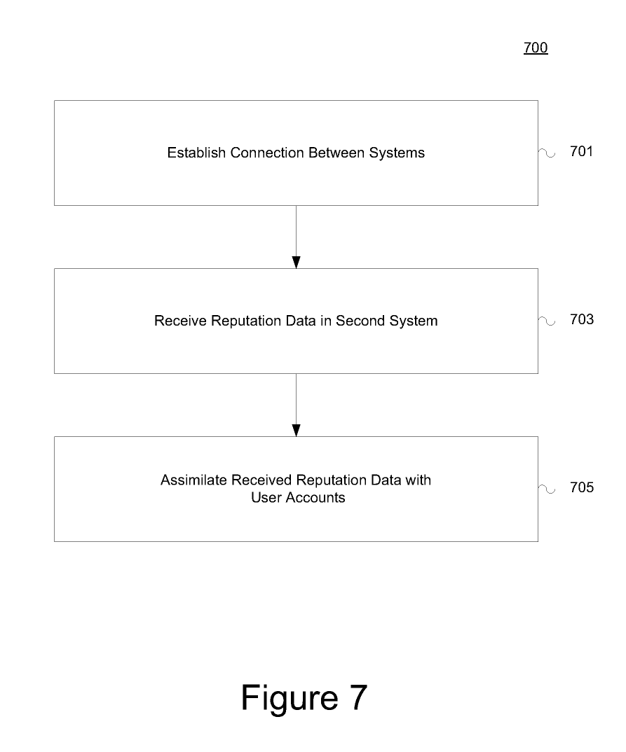

With reference now to FIG. 7, a flowchart 700 of a method of automatically migrating reputation data of a user in a social network from a first system (e.g., a personal reputation system) to a second system is depicted, in accordance with one embodiment. Although specific steps are disclosed in flowchart 700, such steps are exemplary. That is, embodiments of the present invention are well suited to performing various other (additional) steps or variations of the steps recited in flowchart 700. It is appreciated that the steps in flowchart 700 may be performed in an order different than presented, and that not all of the steps in flowchart 700 may be performed.

With reference to step 701, a connection between the first system and the second system is established. Establishing connection may, for example, comprise a request for access from the second system, bypassing a means of authentication from the first system, and a grant of access by the first system to the second system. In one embodiment, the connection is established via an Application Programming Interface, accessed over the Internet. In another embodiment, connection may be established over a local area network. Connection between the first and second system may be established with any conventionally known data transfer protocols.

With reference to step 703, the reputation data of one or more users from the first system is received in the second system through the connection established at step 701. Reputation data for a user may include basic user-supplied information, e.g., name, age, account information, etc . . . Reputation data of a user from a first system may also include, for example, the data the personal reputation index of the user (including behavior records and friend list).

With reference to step 705, the migration of the reputation data acquired in step 703 is completed by assimilating the received data of the one or more users with corresponding presences within the second system. The assimilation may be performed, for example, by linking and/or merging the one or more users whose data was acquired to presences (e.g., accounts) within the second system. For example, reputation data included in a presence (e.g., the personal profile in an established account) in the first system may be merged with existing reputation data included in a presence in the second system.

In one embodiment, migration includes dynamically creating an account to establish the presence of a user on the second account during migration. For example, if the second system does not include a presence of one or more users during the performance of the migration, a presence for each migrating user may be established during the migration at step 705, or earlier (e.g., during acquisition of reputation data at step 703). In a further embodiment, a presence may be implemented as an account within the second system.

### Basic Computing Device

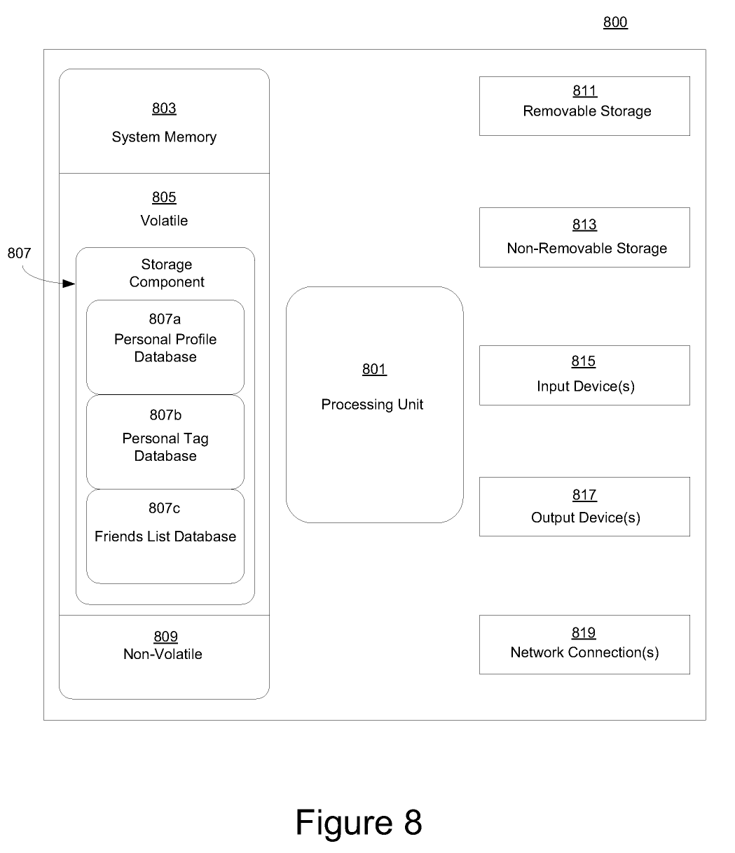

FIG. 8 shows an exemplary computing device 800 according to various embodiments. Computing device 800 depicts the components of a basic computer system providing the execution platform for certain software-based functionality in accordance with various embodiments. Computing device 800 can be an environment upon which personal reputation 100 of a personal reputations system from various embodiments is instantiated. In addition, computer device 800 can be an environment upon which display of personal reputation 200 is implemented, for example.

Computing device 800 can be implemented as, for example, a desktop computer system, laptop computer system or server computer system. Similarly, computing device 800 can be implemented as a handheld device (e.g., cell-phone, etc.) Computing device 800 typically includes at least some form of computer readable media. Computer readable media can be a number of different types of available media that can be accessed by computing device 800 and can include, but is not limited to, computer storage media.

In its most basic configuration, computing device 800 typically includes processing unit 801 and memory 803. Depending on the exact configuration and type of computing device 800 that is used, memory 803 can be volatile (such as RAM) 805, non-volatile 809 (such as ROM, flash memory, etc.) or some combination of the two. In one embodiment, storage component 807 is instantiated in the volatile memory 805. Storage component 807 may include personal profile database 807a, which stores the data comprising personal profiles within the personal reputation system. Storage component 809 may also include personal tag database 807b, comprising a data structure (e.g., a list or array) containing personal tags attached to personal profiles within the personal reputation system. In addition, storage component 807 may include friends list database 807c, which stores a list of other users with established mutual affiliation (e.g. friendship) for each user of the personal reputation system.

Additionally, computing device 800 can include mass storage systems (removable 811 and/or non-removable 813) such as magnetic or optical disks or tape. Similarly, computing device 800 can include input devices 815 and/or output devices 817 (e.g., such as a display). Additionally, computing device 800 can include network connections 819 to other devices, computers, networks, servers, etc. using either wired or wireless media. As all of these devices are well known in the art, they need not be discussed in detail.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for developing personal reputations of users in a social network, the computer system having a processor coupled to a memory, the memory having computer readable code, which when executed by the processor causes the computer system to implement:
a storage component for storing one or more personal profiles corresponding to one or more users of the system, a personal profile including:
a personal reputation index representing a reputation of a corresponding user of the system;
one or more personal tags attached to the personal profile; and
a list of other users with acknowledged affiliations with the corresponding user.

2. The system of claim 1, where the component for storing one or more personal profiles is a database.

3. The system of claim 1, wherein the system further comprises a voting component for allowing users of the system to vote on a personal tag attached to a personal profile of a user of the system.

4. The system of claim 1, the system further comprising a searching component for allowing a user to search for one or more target users of the system based on keywords.

5. The system of claim 4, the system further comprising a path finding component which calculates one or more degrees of separation between a searching user and a target user.

6. The system of claim 1, wherein the personal reputation index of a user further comprises:
an initial index;
a record of behavior of the user; and
an aggregation of the respective indices of reputations for the other users included in the list of other users established as friends by the user.

7. The system of claim 1, wherein a personal tag includes:
an accuracy index; and
a credibility index.

8. The system of claim 1, wherein the personal tag is user-generated.

9. The system of claim 4, wherein a keyword used by a user of the system to search for other users of the system comprises one or more personal tags.

10. The system of claim 1, wherein the system is accessed via the Internet.

11. A method for evaluating a personal tag associated with a user in a personal reputation system, the method comprising:
collecting votes from users in the personal reputation system indicating support or dissent of the personal tag;
calculating the accuracy of the personal tag based on the number of collected votes; and
calculating the credibility of the personal tag based on the reputation of the other users submitting votes on the personal tag.

12. The method according to claim 11, wherein collecting votes from users in the personal reputation system further comprises only collecting votes submitted by users of the system which is not the user whose personal tag is being voted on.

13. The method according to claim 11, wherein each user is eligible to vote once for each personal tag of each other user.

14. The method according to claim 11, wherein votes from users of the personal reputation system are collected only from other users acknowledged by the user as having a relationship with the user whose personal tag is being evaluated.

15. The method according to claim 11, wherein a personal tag associated with a user comprises a descriptive term or short phrase.

16. A method for automatically migrating reputation data of a user in a social network from a first system to a second system, the method comprising:
establishing a connection between the first system and the second system;
receiving in the second system the reputation data of the user of the first system; and
linking the acquired reputation data comprising the reputation data of the user of the first system to an account corresponding to the user in the second system.

17. The method of claim 16, wherein reputation data of a user comprises:
a personal reputation index representing the reputation of the user in a social network;
one or more personal tags associated with the user; and
a list of other users in the social network acknowledged by the user as having a relationship with the user.

18. The method of claim 16, wherein the account corresponding to the user in the second system is pre-established prior to the migration.

19. The method of claim 16, wherein the reputation data from the first system is acquired by the second system over the Internet.

20. The method of claim 16, wherein the reputation data from the first system is acquired by the second system through an application programming interface.
